(19) United States
(12) Patent Application Publication
(10) Pub. No.: US 2016/0350862 A1
(43) Pub. Date: Dec. 1, 2016

(54) METHODS FOR ANALYZING INVESTOR RISK TOLERANCE AND COMPUTER NETWORKS FOR ANALYZING INVESTOR RISK TOLERANCE

(71) Applicant: Lexlan, LLC DBA Tolerisk, Voorhees, NJ (US)

(72) Inventor: Mark S. Friedenthal, Voorhees, NJ (US)

(21) Appl. No.: 15/162,048

(22) Filed: May 23, 2016

Related U.S. Application Data
(60) Provisional application No. 62/166,177, filed on May 26, 2015.

(51) Int. Cl. G06Q 40/06

(52) U.S. Cl. CPC G06Q 40/06

(57) ABSTRACT

A method of analyzing investor risk tolerance is provided. The method includes the steps of: (a) obtaining personal financial information related to an investor; (b) determining a first score for the investor related to the investor's willingness to take risk; (c) determining a second score for the investor related to the investor's ability to take risk; and (d) providing a risk tolerance score for the investor using the first score and the second score.

### CROSS-REFERENCE TO RELATED APPLICATION

This application claims the benefit of U.S. Provisional Patent Application No. 62/166,177, filed May 26, 2015, the content of which is incorporated herein by reference.

### FIELD

The invention relates to the field of investor risk tolerance, and more particularly, to improved methods of analyzing investor risk tolerance, and improved investor risk tolerance computer networks.

### BACKGROUND

In the field of personal financial investment, many investor risk tolerance assessments are simple quizzes taken by the investor (i.e., client). Often, the client does not understand their specific investment risk tolerance because the output from the traditional risk tolerance quiz simply labels them in one of a few broad categories (e.g., aggressive, moderate, conservative, etc.). The category to which the client is labeled may leave the client without a clear measurement of their risk tolerance and without appreciation for the drivers of their risk tolerance. Thus, such clients may not be able to implement a risk directive (and investment strategy) specific enough to their investment needs, and may not anticipate how their risk tolerance will evolve with their circumstances. This may lead clients to make large, sudden changes to their investment risk (e.g., related to a change in their “bucket” status), when they would generally be better served making more gradual changes at a pace commensurate with their unique circumstances.

Thus, it would be desirable to provide improved methods of analyzing investor risk tolerance.

### SUMMARY

According to an exemplary embodiment of the invention, a method of analyzing investor risk tolerance is provided. The method includes the steps of: (a) obtaining personal financial information (e.g., savings, expenses, capital expenditures, assets, retirement income, tax rates, etc.) related to an investor; (b) determining a first score for the investor related to the investor's willingness to take risk; (c) determining a second score for the investor related to the investor's ability to take risk; and (d) providing a risk tolerance score for the investor using the first score and the second score.

According to another exemplary embodiment of the invention, another method of analyzing investor risk tolerance is provided. The method includes the steps of: (a) accessing, by a financial advisor, a software product installed on a remote computer system, the financial advisor using a local computer device to access the software product; (b) answering by the financial advisor, a plurality of questions provided via the software product related to an investor; (c) determining a first score for the investor, using the software product and answers to the plurality of questions provided by the financial advisor, related to the investor's willingness to take risk; (d) answering by the financial advisor, another plurality of questions provided via the software product related to the investor; (e) determining a second score for the investor, using the software product and answers to the another plurality of questions provided by the financial advisor, related to the investor's ability to take risk; and (f) providing a risk tolerance score for the investor using the first score and the second score.

According to another exemplary embodiment of the invention, an investor risk tolerance computer network is provided. The investor risk tolerance computer network includes: (i) a remote computer system, a software product for determining investor risk tolerance being installed on the remote computer system; (ii) a local computer device operated by a financial advisor for accessing the remote computer system; and (iii) a communication path between the remote computer system and the local computer device. The software product on the remote computer system provides a plurality of questions to the financial advisor related to an investor, and the software product determines (i) a first score for the investor related to the investor's willingness to take risk and (ii) a second score for the investor related to the investor's ability to take risk, and the software product provides a risk tolerance score for the investor using the first score and the second score.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a flow diagram illustrating a method of analyzing investor risk tolerance in accordance with an exemplary embodiment of the invention;

FIG. 2 is a flow diagram illustrating another method of analyzing investor risk tolerance in accordance with an exemplary embodiment of the invention;

FIG. 3 is a block diagram illustrating an investor risk tolerance computer network in accordance with an exemplary embodiment of the invention;

FIGS. 4A-4B are illustrations provided via a web page of a software as a service product indicating a score related to an investor's willingness to take risk, and an investor's ability to take risk, respectively, in accordance with an exemplary embodiment of the invention;

FIG. 5 is an illustration provided via a web page of the software as a service product including a risk tolerance chart illustrating a client's ability and willingness to take investment risk in accordance with an exemplary embodiment of the invention;

FIG. 6 is an illustration provided via a web page of the software as a service product depicting the estimated total assets of a client, shown year by year, where the year in which the primary and spouse are expected to retire are highlighted, in accordance with an exemplary embodiment of the invention;

FIG. 7 is an illustration provided via a web page of the software as a service product depicting the estimated future risk tolerance score of a client, shown year by year, where the year in which the primary and spouse are expected to retire are highlighted, in accordance with an exemplary embodiment of the invention;

FIG. 8 is an illustration of a web page of the software as a service product depicting an estimated change in a risk tolerance score of a client for each of a plurality of input assumption changes in accordance with an exemplary embodiment of the invention; and

FIG. 9 is an illustration of a web page of the software as a service product depicting an estimated change in the age at which a client runs out of money for each of a plurality of input assumption changes in accordance with an exemplary embodiment of the invention.

### DETAILED DESCRIPTION

As used herein, the term “financial advisor” is intended to refer to any financial services professional working directly or indirectly with an investor or client including but not limited to investment advisors, brokers, financial planners, financial consultants, financial counselors, amongst others.

As used herein, the term “willingness” is intended to refer to the investor or client's temperament towards investment risk. The term “willingness” is synonymous with the investor or client's “personality” towards investment risk.

As used herein, the term “ability” is intended to refer to the investor or client's capacity for taking investment risk. The “ability” is representative of the chronology of cash-flows (all cash going in and coming out of the client/investor's portfolio and the estimated timing thereof). The “ability” desirably incorporates related financial assumptions including, for example, growth rate, inflation rate, and tax rates, as they may impact cash-flows.

As used herein, the terms “computer device” and “computer system” are intended to refer to any microprocessor based computing device (or group of devices) such as, for example, a computer server, a desktop computer, a laptop computer, a mobile phone, a smart phone, a tablet, etc.

As provided above, many investor risk tolerance profiling tools (e.g., investor “quizzes”) are inadequate because they are too simplistic and lack specificity. The traditional output for many such tools is the assignment of a risk tolerance bucket (or risk tolerance category) to each investor, with exemplary “buckets” including aggressive, moderate, and conservative. Such generic bucketing, with little specificity about the individual investor, typically requires a financial advisor (and/or investor) to hypothesize regarding the actual amount of risk involved in a nebulous bucket/category such as “moderate”.

Such a bucketing methodology may also increase the likelihood that an investor makes a sudden shift in risk profile, as they switch from one bucket to another. This approach places a great significance on the date the actual switch occurs. It is generally more beneficial to make more gradual changes in risk at a pace specific to the investor's confluence of circumstances. The bucketing methodology generally does not afford the financial advisor (and/or investor) much insight on the drivers of the investor's actual risk tolerance. Additionally, such a bucketing methodology does not separately estimate the investor's willingness and ability to take investment risk. The invention addresses these deficiencies.

There is no singular and categorical way to translate investor personality for risk to a specific and completely objective level of investment risk. However, aspects of the invention embody a more scientific approach to quantify both personality (“willingness”) as well as the cash-flow driven capacity (“ability”) to take investment risk.

In accordance with the invention, a risk tolerance score may be provided at a single point in time, or may be provided as a variable over a period of time. The determination of the risk tolerance score involves computer analytics, for example, using a software product (e.g., a hosted software product such as a SAAS product) installed on a remote computer system. The computer analytics uses a plurality of factors in connection with providing the risk tolerance score, where the factors may include financial factors (e.g., the financial assets of the client, etc.), economic factors (e.g., tax rates, growth rates, inflation, etc.), chronological factors (e.g., retirement age, etc.), personality factors, and health related factors. Information regarding the various factors may be provided by a financial advisor (and/or by an investor) answering a plurality of questions/queries.

In accordance with an exemplary embodiment of the invention, a risk tolerance score is provided that is a non-linear combination of the investor's (client's) willingness and ability to take risk. For example, the risk tolerance score may be calibrated to equal the numerator in a growth oriented assets (e.g., stocks) to low risk assets (e.g., bonds) ratio. In a very specific example, a risk tolerance score of 72 means that the investor should have approximately 72% of their investment portfolio allocated to stocks (or other growth/risk related assets) and the balance (28%) of their investment portfolio should be allocated to low risk assets (typically low risk fixed income assets, such as bonds). In this case, “growth/risk related assets” include mutual funds, exchange traded funds that hold stocks (equities), etc. Growth/risk related assets may also include alternative asset classes such as real estate investment trusts, oil & gas pipeline infrastructure, commodities, etc.

The non-linear combination of the investor's willingness and ability to take risk is conceptually as follows. A lower ability score would incorporate less weight on the willingness score in the combined risk tolerance score. A higher ability score would incorporate more weight on the combined risk tolerance score. For example: an investor who is going to use all of their funds to purchase a house in the immediate future (e.g., down payment, closing costs, realtor commissions, furnishings, moving expenses, etc.) would have a minimum ability to take investment risk because any fluctuation in value might compromise the needed usage. In this case, the investor's willingness to take risk is substantially irrelevant, incorporating a minimum weight in the combined risk tolerance score. Alternatively, an investor who will live solely on their pension and social security income, who has no other anticipated withdrawals from their portfolio, may generally have the maximum ability to take risk because their portfolio useage will exhibit the time horizon of their heirs. In this case, their willingness (personality) would be weighted very heavily in their combined risk tolerance score.

Aspects of the invention involve a built-in validation function for the reasonableness of the financial assumptions of the investor. A financial advisor would not want to provide recommendations on risk tolerance if the confluence of assumptions regarding the investor (client) were not realistic. For example: if a 65 year old client, who has $250,000.00 in savings plans on retiring next year and drawing $50,000.00 per year from his account, the software product will highlight that the client is likely to run out of money prematurely, rendering the circumstances untenable. Advice provided by the software product will provide insight as to the likely changes to retirement plans (e.g., timing, expenditures, etc.) needed to make the circumstances more realistic before recomputing the investor's risk tolerance score.

According to certain exemplary embodiments of the invention, a software as a service (SAAS) tool is provided that provides financial advisors with a highly quantifiable method of measuring and analyzing their client's willingness and ability to take investment risk. These may be combined into an actionable and quantifiable risk benchmark expressed as a simple growth/risk related assets to low risk assets ratio (e.g., a stocks-to-bonds ratio). Further analytical information is provided to illustrate the client's sensitivity to certain primary inputs and assumptions. The SAAS tool also provides analytical feedback based on historical economic data and client specific circumstances. All inputs and outputs may be memorialized in an easy to read report. The tool also allows both the financial advisor and the client: (i) to make better decisions regarding investment risk; (ii) to easily review and revise those decisions on an ongoing basis; and (iii) to have greater confidence in those decisions, which facilitates investment discipline.

According to certain exemplary embodiments of the invention, a series of formula are used to measure the client's willingness (personality) to take investment risk separately from their ability (capacity) to take investment risk (chronology of cash-flows), and then combines them to create a measurable risk tolerance score. Exemplary formula used this regard include: (a) formula weighting each answer and each question in the willingness (personality) questionnaire; (b) formula equating each cash-flow (in and out) to a weighted average ability (capacity) to take risk score; and (c) formula (non-linear) to combine willingness and ability into the client's risk tolerance score.

Various types of financial advisors (e.g., financial planners, investment advisors, money managers, CPAs, etc.) may use the invention to help their clients determine the optimal level of risk to take in their investment portfolios. The invention may also be used as a tool to document client information used to determine investment risk tolerance. This memorializes the assumptions as well as the output for both the financial advisor and the client's reference and benefit.

The invention may also be used as a business development tool for financial advisors to gather information about their client or prospective client that may deepen their relationship with their client. The invention may also be used as a sales tool, as financial advisors may use it to showcase their knowledge about investment risk tolerance and their high level of sophisticated service to their clients and prospects.

It is appreciated that too much risk may create a circumstance in which a client can no longer meet some capital obligation, or a circumstance in which they can no longer accept the volatility, causing liquidation at an inopportune time. Too little risk generally means that long term growth is below what is realistically achievable, thus delaying the client's retirement timeframe, reducing the quality of retirement, or decreasing their ability to leave more funds to heirs and desired charities.

Exemplary features of the invention include the following: (a) formulate investor “willingness” to take risk, by weighting both questions and answers differently as they contribute to an overall willingness questionnaire score; (b) formulate a chronology of cash-flows both into and out of the investor's asset base (e.g., including two spouses' assets, income, savings, expenses, etc.), incorporating long-term history for stock and bond data, to ascribe an individual weighted average “ability” to take investment risk; (c) providing a nonlinear, formula which combines the investor's willingness and ability to take risk, and to generate a risk tolerance score, which equates to a simple stocks/bonds ratio for measuring risk; (d) calculating a parametric sensitivity of the risk tolerance score to each of a plurality of input assumptions; (e) calculating a parametric sensitivity of the time until the investor's money runs out to each of the plurality of input assumptions; (f) run large numbers (e.g., thousands) of scenarios, based on, for example, a series of monthly data for equity returns, bond market returns, and inflation, - and layering the investor's specific circumstances (e.g., assets, cash in-flow, cash out-flow, etc.) and measuring when money runs out for each scenario, allowing historically consistent stress test percentiles to be estimated; and (g) estimating risk tolerance as it evolves through time, based on a plurality of user inputs and assumptions.

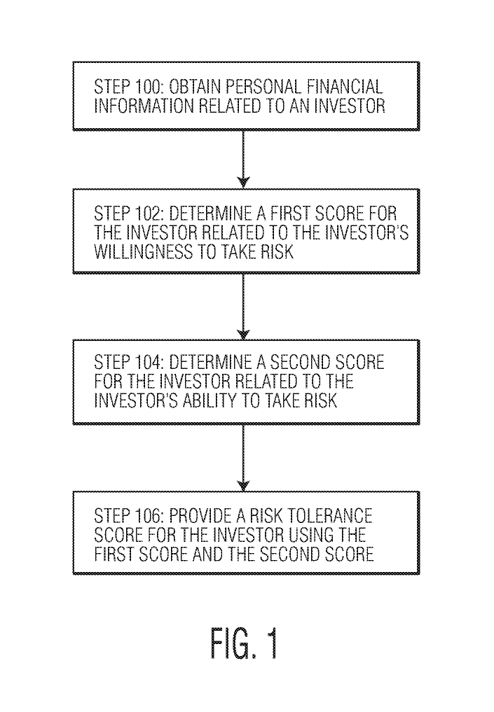

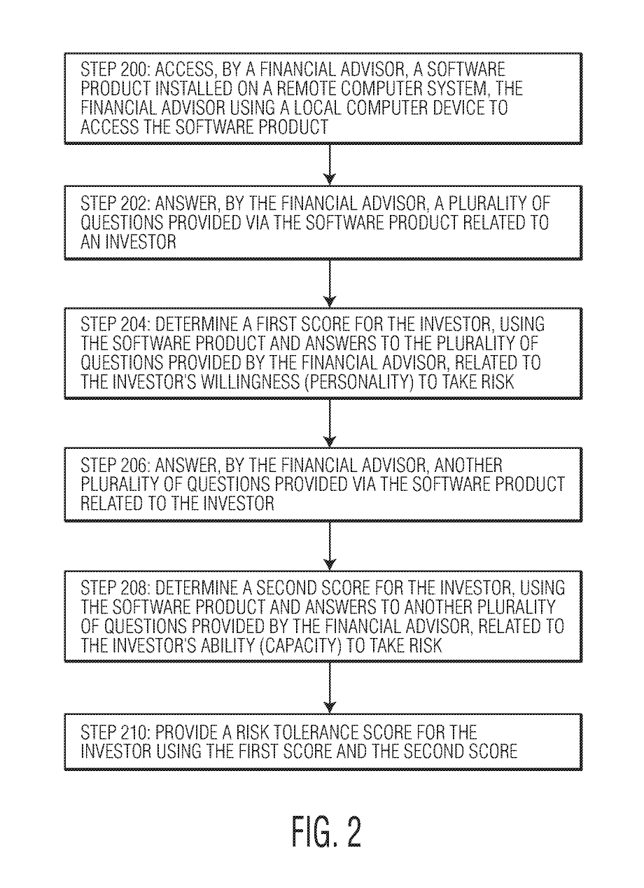

Referring now to the drawings, FIGS. 1-2 are flow diagrams in accordance with certain exemplary embodiments of the invention. As is understood by those skilled in the art, certain steps included in the flow diagrams may be omitted; certain additional steps may be added; and the order of the steps may be altered from the order illustrated.

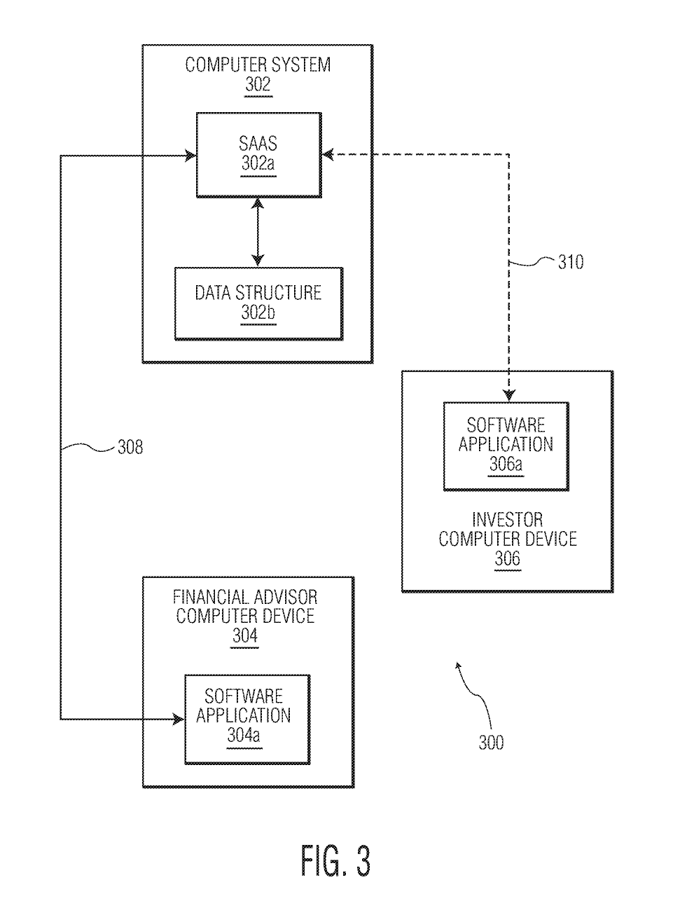

FIG. 1 is a flow diagram illustrating a method of analyzing investor risk tolerance in accordance with an exemplary embodiment of the invention. At Step 100, personal financial information is obtained related to an investor. For example, a financial advisor accesses a hosted software product (e.g., software product 302a illustrated and described in connection with FIG. 3). After logging in (e.g., to validate that the financial advisor is a proper subscriber of the service), the financial advisor may be queried to provide inputs related to the investor.

More specifically, computer analytics are used in connection with Steps 102-106 (and in connection with the method shown in FIG. 2), along with the answers (inputs) to the various queries/questions provided to the financial advisor by using the software product. The answers (inputs) to the various queries/questions may be considered to be a plurality of factors used in connection with providing the risk tolerance score. Examples of such factors include financial factors, economic factors, chronological factors (e.g., age, retirement age), and personality factors (e.g., spending habits, vacation habits, etc), and health related factors.

After obtaining the information described above in connection with Step 100, at Step 102, a first score is determined for the investor related to the investor's willingness to take risk. At Step 104, a second score is determined for the investor related to the investor's ability to take risk. At Step 106, a risk tolerance score is provided for the investor using the first score and the second score.

After the risk tolerance score is determined at Step 106, the software product may provide information to the financial advisor. Such information may include, for example, information regarding actions that may be taken to more closely align the investor's assets with the ratio of the risk tolerance score.

FIG. 2 is a flow diagram illustrating another method of analyzing investor risk tolerance in accordance with an exemplary embodiment of the invention. At Step 200, a software product (e.g., software product 302a shown in FIG. 3) installed on a remote computer system (e.g., computer system 302 shown in FIG. 3) is accessed by a financial advisor. The financial advisor uses a local computer device (e.g., financial advisor computer device 304 shown in FIG. 3) to access the software product. At Step 202, a plurality of questions provided via the software product related to an investor are answered by the financial advisor. As provided above in connection with FIG. 1, such questions may relate to financial factors of the investor, economic factors of the investor, chronological factors (e.g., age, retirement age) of the investor, personality factors (e.g., spending habits, vacation habits, etc) of the investor, and health related factors of the investor. At Step 204, a first score for the investor is determined (e.g., by the analytics in the software product) using the software product and answers to the plurality of questions provided by the financial advisor, related to the investor's willingness to take risk. At Step 206, another plurality of questions provided via the software product related to the investor are answered by the financial advisor. At Step 208, a second score for the investor is determined (e.g., by the analytics in the software product) using the software product and answers to the another plurality of questions provided by the financial advisor, related to the investor's ability to take risk. At Step 210, a risk tolerance score is provided for the investor using the first score and the second score.

As will be appreciated by those skilled in the art, certain information provided by the financial advisor in Steps 202 (and/or Step 206) may determine a conflict according to certain rules (e.g., a conflict between ones of the answers to the plurality of questions, etc.) followed by the software product. In such an event, the software product may prompt a dialogue between the financial advisor and the client before proceeding with the determination of the first (willingness) score at Step 204. Further still, the software product may provide the financial advisor with a manual override capability for overriding the first (willingness) score determined at Step 204.

After the risk tolerance score is determined at Step 210, the software product may provide information to the financial advisor. Such information may include, for example, information regarding actions that may be taken to more closely align the investor's assets with the ratio of the risk tolerance score.

FIG. 3 illustrates an investor risk tolerance computer network 300. Investor risk tolerance computer network 300 includes a remote computer system 302 (e.g., a computer server). A software product 302a (e.g., an SAAS, that is, software as a service product) for determining investor risk tolerance is installed on remote computer system 302. Data structure 302b (which may represent any number of data structures, such as databases, look-up tables, etc.) is also installed on, or is accessible by, remote computer system 302. Such data structure 302b may include information obtained (e.g., from financial advisors, from investors, etc.) related to individual investors, information related to the markets (e.g., historical information related to at least one financial market, trending information, etc.).

Investor risk tolerance computer network 300 also includes a local computer device 304 operated by a financial advisor for accessing remote computer system 302. A software application 304a is installed on local computer device 304 for accessing software product 302a. Communication path 308 (e.g., a wireless or wired Internet based connection) is provided between remote computer system 302 and local computer device 304. A software product 302a (e.g., a SaaS product) on remote computer system 302 provides a plurality of questions to the financial advisor related to an investor, and the software product determines (i) a first score for the investor related to the investor's willingness to take risk and (ii) a second score for the investor related to the investor's ability to take risk. Analytics of the software product are also used to provide a risk tolerance score for the investor using the first score and the second score.

FIG. 3 also illustrates investor computer device 306 which is connected to remote computer system 302 via communication path 310 (e.g., a wireless or wired Internet based connection). As will be appreciated by those skilled in the art, the actual investor (as opposed to a financial advisor associated with the investor) may perform certain of the functions described herein in connection with the financial advisor such as, for example, accessing software product 302a, answering questions/queries provided through the use of software product 302a, receiving a willingness score, receiving an ability score, receiving an investor risk tolerance score, receiving information on how to more closely align the investor's assets with the ratio of the risk tolerance score, etc.

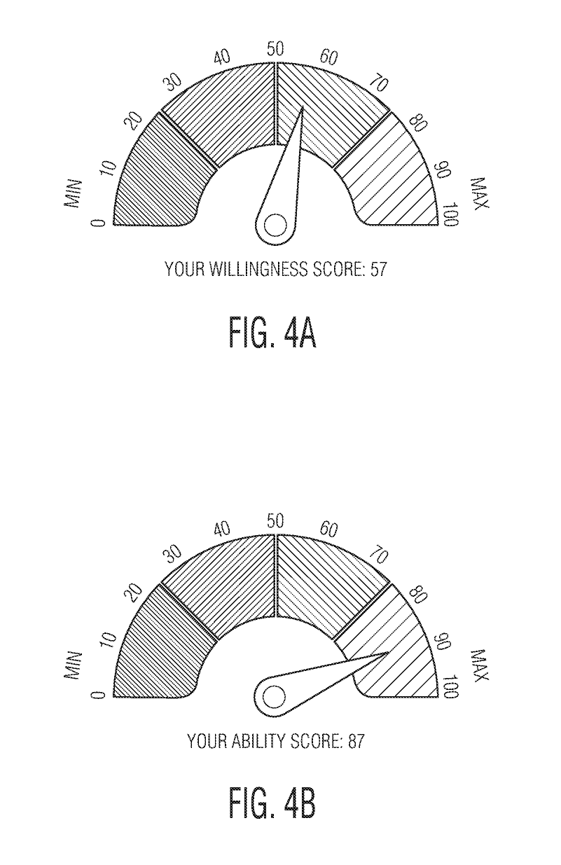

In accordance with the invention, after a determination is made regarding a score for the investor's willingness to take risk, and the investor's ability to take risk, software product 302a may provide illustrations (via a web page) indicating a score related to an investor's willingness to take risk, and/or an investor's ability to take risk. For example, FIG. 4A illustrates a graphical representation of an investor's willingness to take risk—where the graphical representation is provided in the form of a “dial” made up of 4 sections (i.e., section 1 represents a score of 0-25, section 2 represents a score of 25-50, section 3 represents a score of 50-75, and section 4 represents a score of 75-100). Each of the sections 1-4 may be a different color, shade, etc.—which difference is represented in FIG. 4A by each section having a different fill pattern. In the example of FIG. 4A, the investor has a willingness score of 57.

Likewise, FIG. 4B illustrates a graphical representation of an investor's ability to take risk—where the graphical representation is provided in the form of a “dial” made up of 4 sections similar to those described above with respect to FIG. 4A. In the example of FIG. 4B, the investor has an ability score of 87.

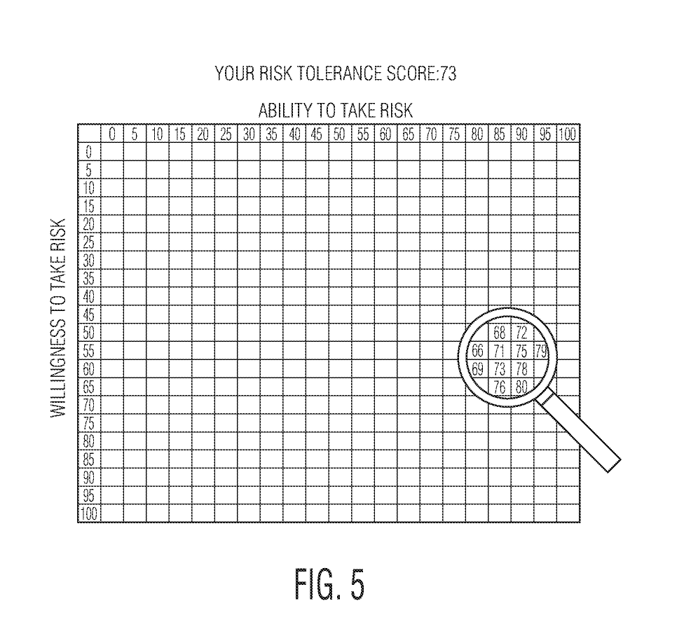

FIG. 5 is an example illustration provided by software product 302a including a risk tolerance chart showing a client's ability to take investment risk (across the x-axis, on a scale of 0 to 100) and the client's willingness to take investment risk (across the y-axis, on a scale of 0 to 100). The intersection of (i) the client's ability to take investment risk and (ii) the client's willingness to take investment risk is the client's risk tolerance score.

The risk tolerance score may be considered to be a ratio of equities (e.g., stocks) to fixed income assets (e.g., bonds). The magnifying glass in FIG. 5 draws the user's attention to the range of risk levels that should be considered, consistent with the client's risk tolerance score. As shown in FIG. 5, the risk tolerance score of the investor with the willingness score shown in FIG. 4A, and the ability score shown in FIG. 4B, is 73. This means that 73 percent of the investor's assets should be invested in growth/risk related assets, while the remainder of the investor's assets (i.e., 27 percent) should be invested in low risk related assets (e.g., low risk fixed income assets).

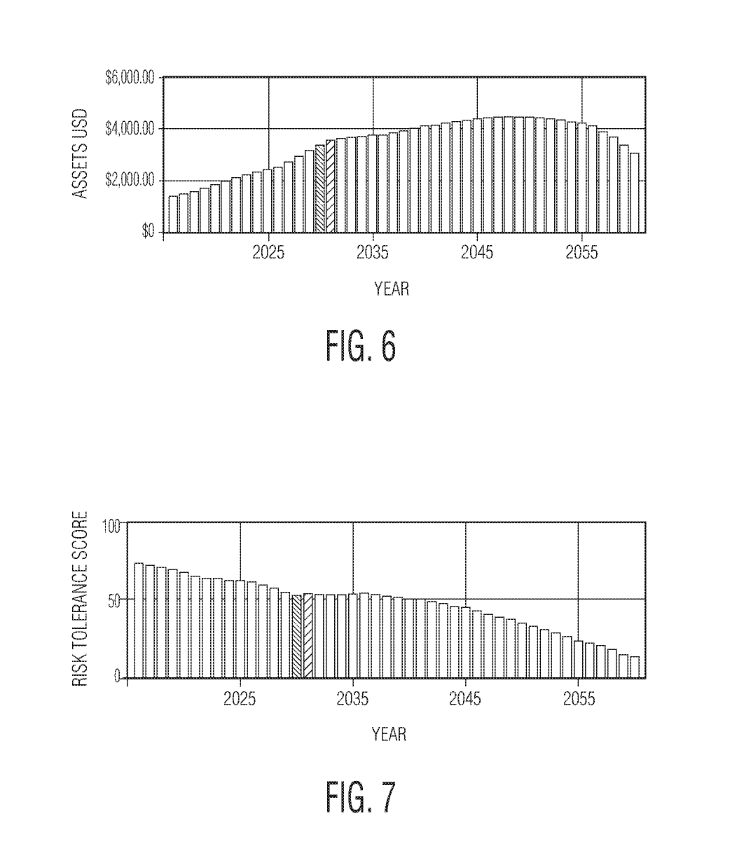

FIG. 6 is an illustration provided via a web page using the software product 302a (accessed by the financial advisor using computer device 304 and/or the investor using computer device 306) depicting the estimated total assets of an investor, depicted year by year, where the year in which the primary and spouse are expected to retire are highlighted. Such a depiction illustrates the estimated assets year by year based on a number of user inputs and assumptions (where such inputs and assumptions may be provided by their financial advisor answering questions/queries from the software product).

FIG. 7 is an illustration provided via a web page using the software product 302a (accessed by the financial advisor using computer device 304 and/or the investor using computer device 306) depicting the estimated future risk tolerance score of the client, provided year by year. This graphical representation is based on certain assumptions coming to fruition. In this illustration, two of the bars of the bar chart are shaded, and represent the years when each of the primary, and the spouse, are expected to retire.

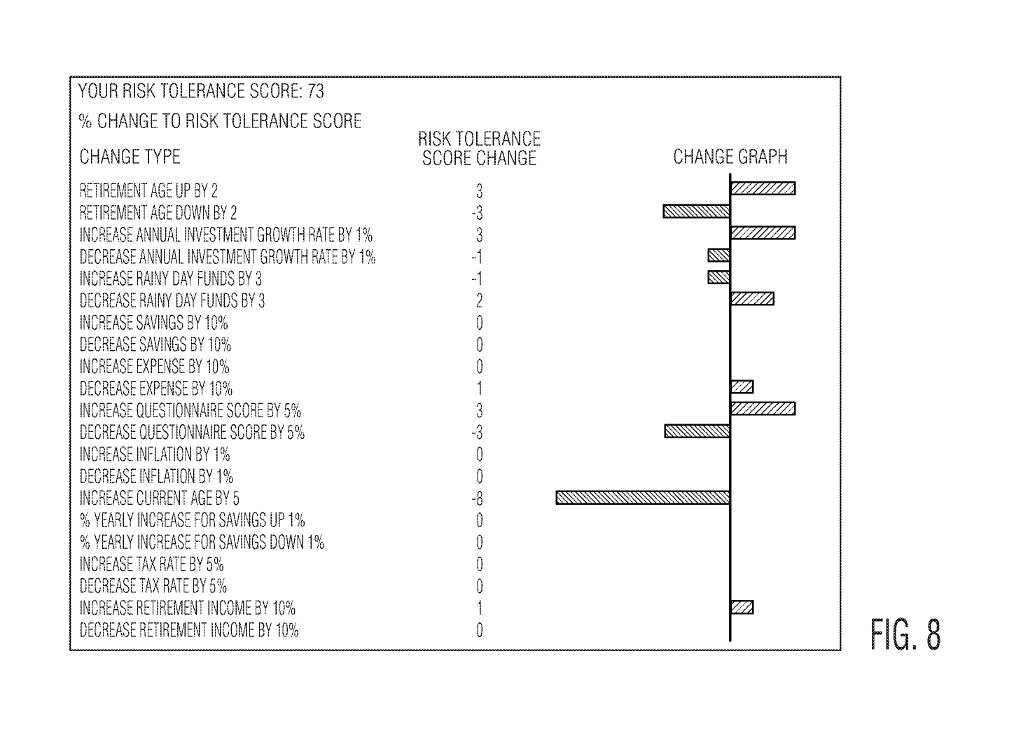

FIG. 8 is a “sensitivity” illustration provided via a web page using the software product 302a (accessed by the financial advisor using computer device 304 and/or the investor using computer device 306), where the web page illustrates estimated (parametrically) changes in the risk tolerance score for each of a number of changes in inputs/assumptions. That is, on the left hand side are a number of changes to inputs/assumptions (e.g., retirement increased by 2 years, retirement decreased by 2, etc.), and in the center is shown the corresponding estimated change in the risk tolerance score. On the right, a graphical (i.e., bar graphs) illustration of the change of the risk tolerance score is provided.

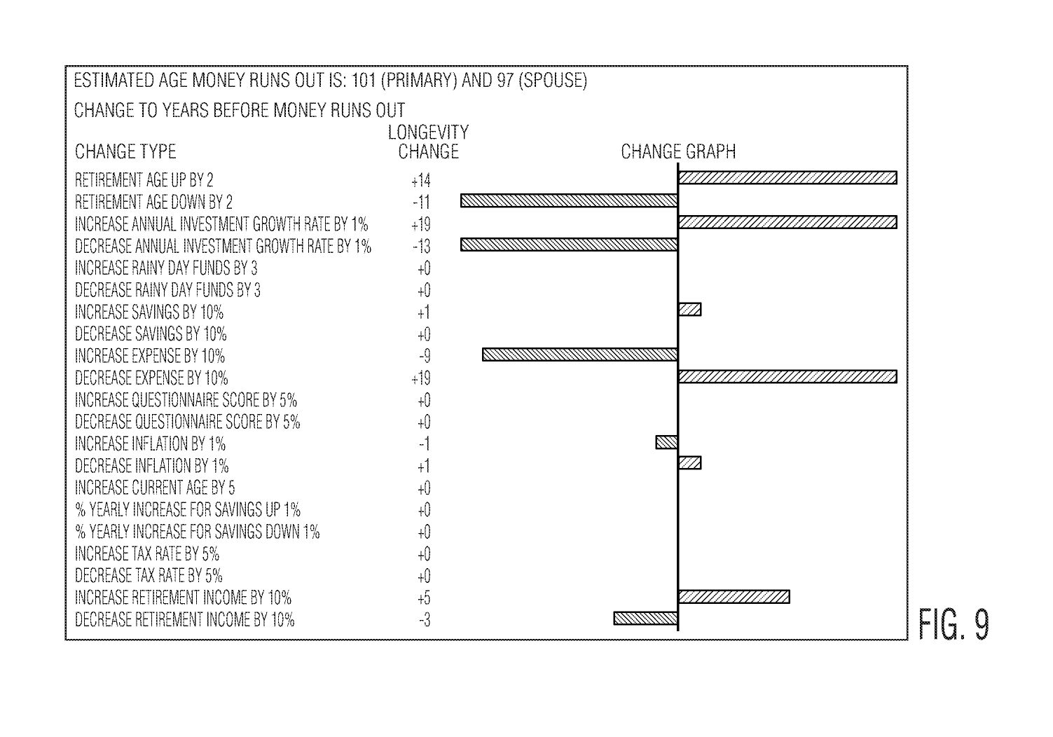

FIG. 9 is a “sensitivity” illustration provided via a web page using the software product 302a (accessed by the financial advisor using computer device 304 and/or the investor using computer device 306), where this web page illustrates estimated (parametrically) changes in the age of the primary (and the spouse) when their money runs out. That is, on the left hand side are a number of changes to inputs/assumptions (e.g., retirement increased by 2 years, retirement decreased by 2, etc.), and in the center is shown the corresponding estimated change in the age of the primary (and the spouse) when their money runs out. On the right, a graphical (i.e., bar graphs) illustration of the change of the age of the primary (and the spouse) when their money runs out is provided.

It is envisioned that goods and services associated with the invention will be marketed to financial advisors. Such advisors may then access a hosted software product (e.g., software product 302a shown in FIG. 3) to utilize the inventive methodology, for example, to advise an investor (client) regarding their immediate (and future) investment strategy. However, it is understood that the invention contemplates investors directly accessing the inventive goods and services themselves (e.g., through a communication path such as path 310 illustrated in connection with FIG. 3).

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of analyzing investor risk tolerance, the method comprising the steps of:
obtaining personal financial information related to an investor;
determining a first score for the investor related to the investor's willingness to take risk;
determining a second score for the investor related to the investor's ability to take risk; and
providing a risk tolerance score for the investor using the first score and the second score.

2. The method of claim 1 wherein the step of providing the risk tolerance score includes using computer analytics in connection with providing the risk tolerance score, wherein the computer analytics uses a plurality of factors in connection with providing the risk tolerance score.

3. The method of claim 2 wherein the factors include financial factors, economic factors, chronological factors, personality factors, and health related factors.

4. The method of claim 1 where the providing step includes providing the risk tolerance score as a variable over a period of time.

5. The method of claim 1 wherein the risk tolerance score is a non-linear combination of the first score and the second score.

6. The method of claim 1 wherein a weighting of the first score in the determination of the risk tolerance score is reduced as the second score decreases.

7. The method of claim 1 wherein a weighting of the first score in the determination of the risk tolerance score is increased as the second score increases.

8. A method of analyzing investor risk tolerance, the method comprising the steps of:
(a) accessing, by a financial advisor, a software product installed on a remote computer system, the financial advisor using a local computer device to access the software product;
(b) answering, by the financial advisor, a plurality of questions provided via the software product related to an investor;
(c) determining a first score for the investor, using the software product and answers to the plurality of questions provided by the financial advisor, related to the investor's willingness to take risk;
(d) answering, by the financial advisor, another plurality of questions provided via the software product related to the investor;
(e) determining a second score for the investor, using the software product and answers to the another plurality of questions provided by the financial advisor, related to the investor's ability to take risk; and
(f) providing a risk tolerance score for the investor using the first score and the second score.

9. The method of claim 8 wherein the software is provided as software as a service (SAAS).

10. The method of claim 8 further comprising the step of prompting a dialogue between the financial advisor and the investor, before step (c), if the software product determines a conflict exists between the answers to the plurality of questions.

11. The method of claim 8 wherein the software product provides the financial advisor with a manual override capability for overriding the first score determined in step (c).

12. The method of claim 8 wherein the risk tolerance score is a non-linear combination of the first score and the second score.

13. The method of claim 8 wherein a weighting of the first score in the determination of the risk tolerance score is reduced as the second score decreases.

14. The method of claim 8 wherein a weighting of the first score in the determination of the risk tolerance score is increased as the second score increases.

15. A risk tolerance computer network comprising:
a remote computer system, a software product for determining investor risk tolerance being installed on the remote computer system;
a local computer device operated by a financial advisor for accessing the remote computer system; and
a communication path between the remote computer system and the local computer,
wherein the software product on the remote computer system provides a plurality of questions to the financial advisor related to an investor, and the software product determines (i) a first score for the investor related to the investor's willingness to take risk and (ii) a second score for the investor related to the investor's ability to take risk, and the software product provides a risk tolerance score for the investor using the first score and the second score.

16. The risk tolerance computer network of claim 15 wherein the communication path is provided via the Internet.

17. The risk tolerance computer network of claim 15 wherein the software product is provided as software as a service (SAAS).

18. The risk tolerance computer network of claim 15 further comprising an investor computer device operated by an investor for accessing the remote computer system.

19. The risk tolerance computer network of claim 15 wherein at least one data structure is installed on the remote computer system, the at least one data structure including information obtained from the financial advisor related to the investor.

20. The risk tolerance computer network of claim 15 wherein at least one data structure is installed on the remote computer system, the at least one data structure including historical information related to at least one financial market.
